(19) United States
(12) Patent Application Publication
(10) Pub. No.: US 2002/0152118 A1
(43) Pub. Date: Oct. 17, 2002

(54) System of a computer-networked, point-of-sale rebate award program

(76) Inventor: George K. Hadjigeorgis, New York, NY (US)

Correspondence Address: HEDMAN & COSTIGAN, P.C., 1185 Anenue of the Americas, New York, NY, 10036, US

(21) Appl. No.: 09/834,503

(22) Filed: Apr. 13, 2001

Related U.S. Application Data
(60) Provisional application No. 60/246,021, filed on Nov. 6, 2000.

(51) Int. Cl. G06F 17/60

(52) U.S. Cl. 705/14

(57) ABSTRACT

A method for making express rebates comprises using a third-party agency for providing for: (a.) communicating, directly or indirectly, a rebate offer by a vendor to a purchaser; (b.) communicating, by computer-networked data-transmission, from the purchaser, directly or indirectly, to the vendor, information verifying rebate-entitlement; (c.) communicating, by computer-networked data-transmission, from the vendor, directly or indirectly, to the purchaser, information verifying rebate-entitlement; and (d.) providing the purchaser with his, hers or its rebate, in full, or less an agent's commission.

The present application claims the benefit of prior filed copending Provisional Application Serial No. 60/246,021, filed Nov. 6, 2000.

### FIELD OF THE INVENTION

This invention relates to a system of process steps operating in association with microprocessor/controllers for improving currently employed mail-in rebate programs with a system which generates an express rebate at the point of sale. More particularly, it relates to computer-networked apparatus and methods for using them to improve the efficiency of rebate programs.

### BACKGROUND OF THE INVENTION

The numerous kinds of rebates that manufacturers, vendors, service providers, and the like, offer to customers to purchase their products or use their services is a matter of common knowledge and experience. One of the most commonly employed is the so-called “mail-in-rebate”, in which at the point-of-sale, be it a brick and mortar retailer or delivery from an internet shopping site, the customer has to receive and mail a copy of a coupon, proof of payment (a few manufacturers do not accept copies of these, requiring originals), proof by way of a universal product code symbol obtained from the original packaging, and a form that has to be filled out and signed by the customer. These materials must then be sent by mail to the manufacturer's, vendor's or provider's agency, by first-class mail, often within a time frame with a set deadline. The rebate check is sent by mail from the agency to the customer's address, finally, some four to eight weeks later.

In the prior art numerous methods have been proposed to provide systems which will allow a consumer of goods and/or services to quickly collect a rebate without the necessity of tending to the above-mentioned paperwork.

By way of illustration, Holda-Fleck U.S. Pat. No. 5,729,693 “SYSTEM AND METHOD TO AUTOMATICALLY PROVIDE AN ELECTRONIC CONSUMER REBATE”, discusses the shortcomings with mail-in rebates and uses the telephone network to process the rebate transaction, and to credit the rebate to a customer's dedicated account, e.g., his telephone bill. Such methods require the consumer to key in or use speech recognition systems with his or her home telephone to request the rebate and does not solve the problem of missing the deadlines, and usually requires waiting for the next, or a later, telephone bill to receive a credit.

Flaten U.S. Pat. No. 5,467,269 “METHOD AND MEANS FOR TELEPHONICALLY CREDITING CUSTOMERS WITH REBATES AND REFUNDS” also discusses the shortcomings with mail-in rebates and uses the telephone network to process the rebate transaction, and the telephone company to designate an agency to credit the rebate to a customer's dedicated account, e.g., his or her telephone bill. Here again, this method does not solve the problem of missing the deadlines, and the consumer usually has to wait for the next, or later, telephone bill to receive a credit.

Finsterwald U.S. Pat. No. 6,039,244 “METHOD OF BUILDING UP A DATA BANK CONTAINING CUSTOMER DATA AND/OR FOR THE ORGANIZATION OF A REBATE OR COUPON SYSTEM” discusses rebate systems and uses communications networks such as the internet with microprocessors/controllers or the telephone network to process the rebate transaction, based on a secret unique code handed out with the product or services, and to transmit the rebate. This method requires the manufacturer of goods or the provider of services to modify their standard packaging to creating and hiding from view by others a unique code which the consumer must locate after the point-of-purchase and key into the system and wait for his or her rebate.

Johnson U.S. Pat. No. 5,924,080 “COMPUTERIZED DISCOUNT REDEMPTION SYSTEM” discloses a method of processing merchandise discounts by providing a computerized membership system. This has the disadvantage of requiring that the member must pre-register before approaching the checkout counter so a computer can recognize him by a member number, e.g., which is, for example, embossed on a membership card and stored in a data base in a remote server connected to the cash register. Furthermore, if the member is dissatisfied with the quality of the goods or services, he or she (unless the sale is “final”), and the manufacturer or service provider, and any of their designees, will have difficulty processing returns and request for refunds. Such problems can obviously cause a loss of good will toward the retailer or service provider and even the manufacturer, and qualifying for the membership number can raise privacy issues for the customer.

Walker et al U.S. Pat. No. 6,049,778 “METHOD AND APPARATUS FOR ADMINISTERING A REWARD PROGRAM” discloses a method of increasing sales by providing a computerized system to reward purchasers of new products, especially early-adopter purchasers, by sending cash or products, crediting an account, or discounting future purchases. This has the disadvantage of requiring that the purchaser must wait until the product is successfully launched to earn a discount, an especially long time, even if compared to mail-in rebates, if the reward is based on the number of units sold.

It has now been found that modification of such mail-in and networked rebate programs in a judiciously selected way produces surprising benefits in terms of efficiency and customer satisfaction. The modifications comprise, primarily, using a third-party agency for introducing a novel means for computer-networked registration at the point of purchase, and entry of the necessary data for rebate fulfillment along with the rest of the usual transaction data, e.g., cash or credit card or the like. As soon as fulfillment is confirmed, the rebate, less the agency's commission, becomes an item held in trust for the customer's benefit, for a period of time sufficient to confirm the customer's satisfaction with the goods and/or services, and compliance with any restrictions, such as only one rebate per household, following which the agency will distribute the rebate, less the agency's commission, by way of a check, a credit card credit, or an electronic funds transfer, or the like. In the case of “final” sales transactions, the customer's satisfaction can be presumed, and the rebate, less the agency's commission, can be disbursed at the point of purchase, i.e., it becomes an instant express rebate.

The benefits of using a third-party agency in the express rebate program herein flow to:

(1) the manufacturer, who can increase customer satisfaction, increase sales, and eliminate the need to use third parties, such as mail-in service bureaus to collect and evaluate proofs of purchase and for cutting and mailing rebate checks;

(2) other intermediaries, such as banks, internet vendors, credit card processors, and the like, who see their businesses increase when a consumer shops for goods that offer an express rebate in accordance with the present invention;

(3) the retailer who experiences an increase in sales by offering express rebates in accordance with the present invention, and

(4) the customer by being certain that he, she or it (organization) are not going to miss any deadline for submission of proofs of purchase and forget to mail, lose necessary receipts, and the time and effort involved in putting together and mailing all required items.

### SUMMARY OF THE INVENTION

In accordance with the present invention, there is provided a system for making express rebates comprising using a third-party agency for providing means for:

a. communicating, directly or indirectly, a rebate offer by a vendor to a purchaser;

b. communicating, by computer-networked data-transmission means, from purchaser, directly or indirectly, to vendor, information verifying rebate-entitlement;

c. communicating, by computer-networked data-transmission means, from vendor, directly or indirectly, to purchaser, information verifying rebate-entitlement; and

d. providing the purchaser with his, hers or its rebate, in full, or less said third-party agency's commission.

Among the preferred embodiments of the present invention are

a method as described wherein a retailer processes the express rebate transaction at a retail check out counter by scanning in the data necessary to fulfill the rebate requirements;

a method as described, wherein a retailer processes the express rebate transaction at a retail check out counter by engaging as the third-party agency one wherein the applicant herein, or his designee, becomes an agent for the benefit of the purchaser for the purpose of paying the rebate, less the agent's commission, to the purchaser, subject to the purchaser's satisfaction with the goods and/or services, instantly, in the case of “final” sales; and

a method as described, wherein a vendor offers an express rebate in accordance with the present invention on a computer-networked site on which the applicant herein, or his designee, has been appointed a third-party agency for the benefit of the purchaser for the purpose of paying an express rebate, in full, or less the third-party agent's commission; the purchaser agrees to accept the conditions of the promotion and transmits all necessary data to the vendor; and the agent collects and pays over the rebate, in full, or less the agent's commission, to the purchaser by check or other means.

### DETAILED DESCRIPTION OF THE PREFERRED EMBODIMENTS

Broadly speaking, the methods of the present invention are carried out in an apparatus well known to those skilled in the art. In this connection, specific mention is made of the specifications and drawings of Walker et al, U.S. Pat. No. 6,049,778 and of Flaten, U.S. Pat. No. 5,467,269, which are both incorporated herein in their entirety, to avoid the need for unnecessarily detailed description.

Typically, an apparatus for administering a rebate program includes at least a central controller in communication with one or more data input devices. Each of the data input devices is adapted to collect registration information directly from purchasers at the point-of-sale without intervention or the need to consult with any other humans. Such information is of the usual type called for by mail-in rebate systems, including, but not limited to, (i) the product purchased; (ii) a serial number or other unit identifier for specifying the particular unit of the product which was purchased; (iii) the name of the purchaser; (1v) the address of the purchaser; (v) the location of where the product was purchased; (vi) the price paid for the product; and (vii) the date of purchase.

In one embodiment, the purchaser may enter the registration information via one of the data input devices, which may be in a kiosk located in a store. The kiosk in turn transmits the registration information to the central controller over a computer network. In another embodiment, one of the data input devices is a point-of-sale terminal, such as a cash register with a scanner/reader adapted to transmit a purchase price, product code and other items of registration to the central controller over a computer network. In a further embodiment, at least one of the data input devices is a personal computer on a communication network, such as the internet. Without the need for further human intervention, the personal computer (i) initiates an order, (ii) collects registration information along with the order, and (iii) submits the order and registration information to the central controller.

The central controller comprises a processor, such as one or more conventional microprocessors which is connected to a data storage device, such as a hard disk, or the like. The processor is in communication with each of the data input devices.

The data storage device stores, at least: (i) an operating program for controlling the processor; (ii) a registration database; (iii) a rebate database and (iv) an account database.

The registration database stores entries which together define a registration. Each of the entries include information, such as (i) a product identifier for specifying the product that was purchased; (ii) a unit identifier for specifying a particular unit of the product that was purchased; (iii) a name of a purchaser; (iv) an address of the purchaser; (v) a store identifier for specifying a store, if any, where the product was purchased; (vi) a purchase price of the product; and (vii) a purchase date of the product.

A rebate database is used to generate a balance of rebates accruing to each purchaser and to the third party agency, discounted for the agency's commission or enhanced in the amount of the agency's commission to be paid by the vendors, as the case may be.

An account database is used to generate a balance of rebates accruing to each purchaser and to the third party agency, discounted for the agency's commission or enhanced in the amount of the agency's commission to be paid by the vendors, as the case may be. In the account database are stored entries specifying (i) an account identifier for uniquely specifying each account; (ii) an account balance in favor of the purchaser; (iii) the name of the purchaser, (iv) the address of the purchaser; (v) a verifier for specifying whether a rebate had already been credited to this account; and (vi) an account balance for the commission in favor of the agency.

When account balances are cashed out, which can be immediately in the case of final sales, the purchaser can initiate such cashing out, for example, via an internet site or a voice response unit over a telephone, the central controller may determine when purchasers are cashed out. Such payments, if not requested immediately can be (i) credited to a credit card account or other financial account, (ii) mailed to the purchaser in the form of a check or product, or (iii) sent to stores or other predetermined locations until picked up by the purchaser.

In those instances wherein the agency's commission is the responsibility of the manufacturer, service provider, or retailer, the microprocessor/controller can include one or more data output devices and the accounting database (or a dedicated database) can be adapted to store information as to the sources and amounts standing in favor of the agency. The apparatus can be set up in ways well known to those skilled in this art to communicate with the source(s) for the purposes of invoicing, reporting sales subject to rebates, reporting sales data and registration information and receiving payment for agency expenses and commission.

### EXEMPLARY EMBODIMENTS

As a first example, Purchaser John Doe learns of a $20 rebate offer by software Vendor Acme Corp. toward the purchase of a Tax Program at a retail price of $99.95. By pre-arrangement Acme has contracted with Third-Party Agency Dick to provide fulfillment services in connection with the offer. Using the internet, to connect to a microprocessor serving both Vendor Acme and Agency Dick, Purchaser Doe accepts the offer and provides his name, home address, work phone number, home phone number, and E-mail address to a Customer data base and receives a Confirmation of his order by E-mail. Vendor Acme advises Purchaser Doe and Agency Dick upon shipment of the order and confirms receipt of the $99.95 payment. $20.00 is transmitted via computer by Vendor Acme to Agency Dick who in-turn transmits via computer to Purchaser Doe his net rebate: $19.50 ($20.00, less a 5% agency fee).

As a second example, the facts are the same as in the first example, except that the Vendor Acme transmits $20.50 ($20.00, plus a 5% agency fee) to Agency Dick who in turn transmits to Purchaser Doe the full rebate: $20.00.

As a third example, Purchaser Ken Roe, who usually buys another brand of beer, during a visit to his local Retailer Baker Beverages learns of a $2 rebate offer by Brewer Carl Corp. toward the purchase of each of up to 10 cases of 24 cans at a retail price of $9.95+$1.20 deposit for each case. By pre-arrangement Carl has contracted with Third-Party Agency Dick to provide fulfillment services in connection with the offer. Using Retailer Baker's computer terminal/scanner/cash register and the Internet to connect to a microprocessor/controller serving both Brewer Carl and Agency Dick, Purchaser Roe accepts the offer, buys 10 cases, and provides his name, home address, work phone number, home phone number address to a Customer data base, maintained by Agency Dick and accessible by Brewer Carl and Retailer Baker, and receives a Confirmation of his order by visual display on the cash register. Vendor Carl advises Retailer Baker, Purchaser Roe and Agency Dick upon confirmation by Baker of delivery of the order and receipt of the $99.95+1.20 payment, from Roe. $20.00 is immediately transmitted via computer by Vendor Carl to Agency Dick who in-turn transmits via computer to Purchaser Roe his net rebate: $19.50 ($20.00, less a 5% agency fee).

As a fourth example, Purchaser Alan P. Poe, who read a newspaper advertisement, learns of a $100 rebate offer by Manufacturer Camera Corp. toward the purchase of a digital camera at a “final sale” retail price of $999.00. Participating Retailer Charlie was listed in the advertisement. By pre-arrangement Camera Corp. has contracted with Third-Party Agency Dick to provide fulfillment services in connection with the offer. Using Retailer Charlie's computer terminal/scanner/cash register and the internet to connect to a microprocessor serving both Manufacturer Camera Corp. and Agency Dick, Purchaser Poe accepts the offer and provides his name, home address, work phone number, home phone number to a Customer data base and receives a Confirmation of his order by visual display on the cash register. Manufacturer Camera advises Retailer Charlie, Purchaser Poe and Agency Dick upon confirmation by Charlie of delivery of the order and receipt of the $999.95 payment, by Poe. $100.00 is immediately transmitted via computer by Manufacturer Camera to Agency Dick who in-turn transmits via computer to Retailer Charlie for payment in cash to Purchaser Poe his net rebate: $95.00 ($100.00, less a 5% agency fee).

In those cases wherein Alan Poe's camera purchase is not a “final sale” but includes a time-limited, e.g., 30 day, money-back-guarantee, any claim for a full refund of the purchase price can instantly be satisfied, but only after deducting the amount of the net rebate. This is an improvement over the known practice of denying such a claim after a mail-in rebate registration is filed.

To minimize the need for unnecessarily detailed description, the disclosures of the patents and provisional application specifically identified herein are incorporated herein by reference.

Since other modifications and changes varied to fit particular operating requirements and environments will be apparent to those skilled in the art, the invention is not considered to be limited to the examples chosen for the purposes of disclosure, and the claims cover all changes and modifications which do not constitute departures from the true spirit and scope of this invention.

1. A method for making express rebates comprising using a third-party agency for providing means for:
a. communicating, directly or indirectly, a rebate offer by a vendor to a purchaser;
b. communicating, by computer-networked data-transmission means, from purchaser, directly or indirectly, to vendor, information verifying rebate-entitlement;
c. communicating, by computer-networked data-transmission means, from vendor, directly or indirectly, to purchaser, information verifying rebate-entitlement; and
d. providing the purchaser with his, hers or its rebate, in full, or less an agent's commission.

2. A method as defined in claim 1 wherein a retailer processes the express rebate transaction at a retail check out counter by scanning in the data necessary to fulfill the rebate requirements.

3. A method as defined in claim 1 wherein a retailer processes the express rebate transaction at a retail check out counter by creating an agency wherein the applicant herein, or his designee, becomes an agent for the benefit of the purchaser for the purpose of paying the rebate, in full, or less the agent's commission, to the purchaser, subject to the purchaser's satisfaction with the goods and/or services, and instantly, in the case of “final” sales.

4. A method as defined in claim 1 wherein a retailer processes the express rebate transaction at a retail check out counter by creating an agency wherein the applicant herein, or his designee, becomes an agent for the benefit of the purchaser for the purpose of paying the rebate, in full, or less the agent's commission, to the purchaser, instantly, in the case of “final” sales.

5. A method as defined in claim 1 wherein a vendor offers an express rebate in accordance with the present invention on a computer-networked site on which the applicant herein, or his designee, has been appointed an agent for the benefit of the purchaser for the purpose of paying an express rebate, in full, or less the agent's commission; the purchaser agrees to accept the conditions of the promotion and transmits all necessary data to the vendor; and the agent collects and pays over the rebate, in full, or less the agent's commission, to the purchaser by check or other means.
